(19) United States
(12) Patent Application Publication
(10) Pub. No.: US 2007/0074806 A1
(43) Pub. Date: Apr. 5, 2007

(54) Production method of multilayer ceramic electronic device

(75) Inventors: Tatsuya Kojima, Nikaho-shi (JP); Raitaro Masaoka, Nikaho-shi (JP); Takako Murosawa, Nikaho-shi (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/527,574

(22) Filed: Sep. 27, 2006

(30) Foreign Application Priority Data
Sep. 30, 2005 (JP) 2005-288157

(51) Int. Cl. C03B 29/00

(52) U.S. Cl. 156/89.16; 156/89.12; 156/89.14

(57) ABSTRACT

By a production method for producing a multilayer ceramic electronic device including dielectric layers and internal electrode layers comprising the steps of forming a green sheet to be said dielectric layer after firing, forming a pre-fired electrode layer to be said internal electrode layer after firing in a predetermined pattern on said green sheet by using a conductive material paste, forming a green chip by successively stacking said green sheets and said pre-fired electrode layers, and firing said green chip: wherein the conductive material paste for forming said pre-fired electrode layer is composed at least of conductive material particles, a first common material composed of ceramic powder and a second common material composed of ceramic powder having a larger average particle diameter than that of said first common material; an average particle diameter of said first common material is 1/20 to ½ of an average particle diameter of said conductive material particles; and the average particle diameter of said second common material is 1/10 to ½ of an average thickness of said internal electrode layers after firing; a multilayer ceramic electronic device, such as a multilayer ceramic capacitor, wherein arising of cracks is effectively prevented, having a low short-circuit defect rate, a low voltage resistance defect rate and high capacitance is produced.

### BACKGROUND OF THE INVENTION

1. Field of the Invention

The present invention relates to a production method of a multilayer ceramic electronic device, such as a multilayer ceramic capacitor, and particularly relates to a production method of a multilayer ceramic electronic device, wherein arising of cracks is prevented, a short-circuit defect rate is low and a voltage resistance failure rate is low, moreover, a high electrostatic capacitance is given.

2. Description of the Related Art

A multilayer ceramic capacitor as a multilayer ceramic electronic device is widely used as a highly reliable compact electronic device having a large capacity and used by a large number in one electronic apparatus. In recent years, as the apparatuses become more compact and higher in performance, demands for a multilayer ceramic capacitor to be more compact with a larger capacity, lower at cost and higher in reliability have become still stronger.

To pursue downsizing and a higher capacity as above, it has been implemented to make thicknesses of dielectric layers and internal electrode layers thinner (attaining thinner layers) and to increase the number of stacking them as much as possible (stacking a larger number of layers). However, when attaining thinner layers and stacking a larger number of layers, there are disadvantages that an interlayer detaching phenomenon (delamination) and cracks are easily caused due to an increase of boundary surfaces between the dielectric layers and the internal electrode layers, etc., so that arising of short-circuit defects is caused thereby.

On the other hand, for example, in the patent article 1 (The Japanese Unexamined Patent Publication No. 2000-277369), conductive paste including as common materials first ceramic powder and second ceramic powder having different particle diameters is disclosed as conductive paste for forming internal electrode layers of a multilayer ceramic capacitor. Particularly, in the article, fine ceramic powder is used as the first ceramic powder and ceramic powder having a larger particle diameter (specifically, a particle diameter of 3 μm in the embodiment) than a thickness of each internal electrode (specifically, about 2.5 μm in the embodiment) is used as the second ceramic powder.

According to the patent article 1, by using such conductive paste, delamination and cracks are suppressed as a result that an internal electrode layer includes ceramic particles having a large particle diameter that reaches from a ceramic layer on one side of an internal electrode layer to a ceramic layer on the other side of the internal layer. However, in the patent article 1, there is a disadvantage that the ceramic particles having a large particle diameter included in the internal electrode layers form breaking parts of electrodes, so that the capacitance declines due to an effect of the breaking parts, as a result, a larger capacity cannot be attained.

Furthermore, in the article, since ceramic powder having a large particle diameter (particularly, ceramic powder having a larger particle diameter than a thickness of an internal electrode) is used as the second ceramic powder as explained above, disadvantages below have been caused. Namely, when using such ceramic powder having a large particle diameter, a thickness of an adjacent dielectric layer is affected by the ceramic powder having a large particle diameter and, particularly, there has been a phenomenon that the adjacent dielectric layer becomes partially thin. This also caused disadvantages that the short-circuit defect rate and the voltage resistance defect rate are deteriorated as the result.

### SUMMARY OF THE INVENTION

The present invention has been made in consideration of the above circumstances and has as an object thereof to provide a production method of a multilayer ceramic electronic device, such as a multilayer ceramic capacitor, having a low short-circuit defect rate, a low voltage resistance defect rate and, moreover, a high capacitance, wherein arising of cracks is effectively prevented.

To attain the above object, according to the present invention, there is provided a production method for producing a multilayer ceramic electronic device including dielectric layers and internal electrode layers, comprising the steps of:

forming a green sheet to be the dielectric layer after firing;

forming a pre-fired electrode layer to be the internal electrode layer after firing in a predetermined pattern on the green sheet by using a conductive material paste;

forming a green chip by successively stacking the green sheets and the pre-fired electrode layers; and

firing the green chip;

wherein the conductive material paste for forming the pre-fired electrode layer is composed at least of conductive material particles, a first common material composed of ceramic powder and a second common material composed of ceramic powder having a larger average particle diameter than that of the first common material;

an average particle diameter of the first common material is 1/20 to ½ of an average particle diameter of the conductive material particles; and

the average particle diameter of the second common material is 1/10 to ½ of an average thickness of the internal electrode layers after firing.

In the present invention, paste including the first common material having a predetermined average particle diameter is used as conductive material paste for forming internal electrode layers. Therefore, spheroidizing of internal electrode layers caused by particle growth of conductive material particles can be effectively prevented in the firing step and the capacitance can be maintained high.

Furthermore, in the present invention, the second common material having a larger average particle diameter than that of the first common material is furthermore included in the conductive material paste. The second common material sinters mainly near boundary surfaces of internal electrode layers and dielectric layers and, after firing, exists as ceramic particles protruding from the dielectric layer side to interlayer electrode layers. Due to the anchor effect by the protruding ceramic particles to the internal electrode layers, bonding strength between the internal electrode layers and the dielectric layer can be increased, as a result, arising of cracks (particularly, arising of cracks caused by delamination) can be effectively prevented.

Moreover, in the present invention, an average particle diameter of the second common material is controlled to be in a range of 1/10 to ½ of a thickness of an internal electrode layer after sintering, so that it is possible to attain the configuration that the ceramic particles formed by the second common material and protruding to the internal electrode layer do not penetrate the internal electrode layer. Therefore, high capacitance can be realized without causing breakings of internal electrode layers. Also, as a result that an average particle diameter of the second common material is in the above range, a thickness of adjacent dielectric layer is not affected thereby, so that the short-circuit defect rate and voltage resistance defect rate are not deteriorated.

In the present invention, preferably, an average particle diameter of the second common material is 0.2 to 0.5 μm.

In the present invention, preferably, a content of the first common material in the conductive material paste is 5 to 35 parts by weight with respect to 100 parts by weight of the conductive material particles. When the content of the first common material is too small, the effect of suppressing spheroidizing of internal electrode layers becomes hard to be obtained. While when the content of the first common material is too large, a coverage rate of the internal electrode layers after firing declines, as a result, the capacitance is liable to decline.

In the present invention, preferably, a content of the second common material in the conductive material paste is larger than 1 part by weight and less than 15 parts by weight with respect to 100 parts by weight of the conductive material particles. When the content of the second common material is too small, the anchor effect to the internal electrode layers obtained by forming ceramic particles protruding to the internal electrode layers as explained above is hard to be obtained. While when the content of the first common material is too large, it is liable that the short-circuit defect rate and voltage resistance defect rate are deteriorated.

A multilayer ceramic electronic device according to the present invention is not particularly limited, and a multilayer ceramic capacitor, piezoelectric device, chip inductor, chip varistor, chip thermistor, chip resistor, and other surface mounted chip electronic devices (SMD), etc. may be mentioned.

Note that, in the present invention, the coverage rate is, when assuming that an ideal area of covering dielectric layers by internal electrode layers was 100% when there was no electrode breaking portion on the internal electrode layers, a ratio of an area that internal electrode layers actually cover the dielectric layers with respect to an ideal area that internal electrode layers cover the dielectric layers. Also, in the present invention, an average particle diameter of respective particles and powder means an average value of SEM diameters by SEM observation.

According to the present invention, as conductive material paste for forming internal electrode layers, paste including the first common material having a predetermined average particle diameter and the second common material having a larger average particle diameter than that of the first common material is used. Therefore, in addition to an effect of preventing spheroidizing of internal electrode layers by the first common material, the ceramic particles protruding to the internal electrode layers formed by the second common material sintered near the boundary surfaces between the internal electrode layers and dielectric layers effectively prevents arising of cracks (particularly, arising of cracks caused by delamination).

Particularly, in the present invention, a common material, wherein the average particle diameter is controlled to be in a range of 1/10 to ½ of a thickness of each internal electrode layer after sintering is used as the second common material. Therefore, in the patent article 1 (the Japanese Unexamined Patent Publication No. 2000-277369) explained above, a decline of capacitance due to electrode breakings and deterioration of the short-circuit defect rate and voltage resistance defect rate caused by affecting on a thickness of adjacent dielectric layer can be prevented. Therefore, according to the present invention, arising of cracks can be effectively prevented, the short-circuit defect rate and voltage resistance defect rate can be suppressed low and, furthermore, the capacitance can be maintained high.

### BRIEF DESCRIPTION OF DRAWINGS

These and other objects and features of the present invention will become clearer from the following description of the preferred embodiments given with reference to the attached drawings, in which:

FIG. 1 is a sectional view of a multilayer ceramic capacitor according to an embodiment of the present invention;

FIG. 2 is an enlarged sectional view of a multilayer ceramic capacitor according to an embodiment of the present invention; and

FIG. 3 is a view showing a fine structure of a ceramic particle protruding to an internal electrode layer according to an embodiment of the present invention.

### DESCRIPTION OF THE PREFERRED EMBODIMENT

Multilayer Ceramic Capacitor

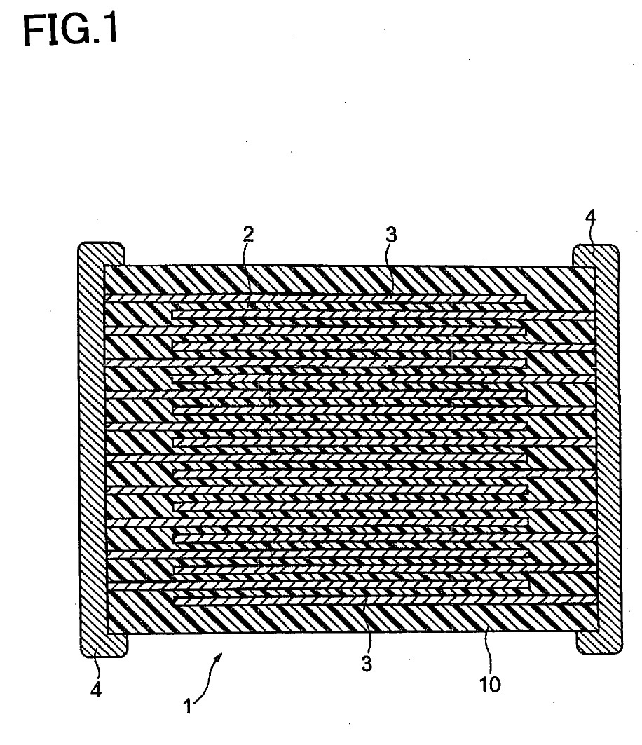

As shown in FIG. 1, a multilayer ceramic capacitor 1 according to an embodiment of the present invention has a capacitor element body 10 configured by alternately stacked dielectric layers 2 and internal electrode layers 3. End portions on both sides of the capacitor element body 10 are formed with a pair of external electrodes 4 respectively conducting to the internal electrode layers 3 arranged alternately in the element body 10. The internal electrode layers 3 are stacked, so that the respective end surfaces are exposed alternately to surfaces of two facing end portions of the capacitor element body 10. The pair of external electrodes 4 are formed on both end portions of the capacitor element body 10 and connected to the exposed end surfaces of the alternately arranged internal electrode layers 3, so that a capacitor circuit is configured.

A shape and size of the capacitor element body 10 are not particularly limited and may be suitably set in accordance with the use object, but is normally rectangular parallelepiped and the size may be normally a length (0.4 to 5.6 mm)×width (0.2 to 5.0 mm)×height (0.2 to 2.5 mm) or so.

A conductive material included in the internal electrode layers 3 is not particularly limited, but when using a reduction-resistant material as a component of the dielectric layers 2, base metals may be used. As base metals to be used as the conductive material, Ni, Cu, a Ni alloy and a Cu alloy are preferable. When a main component of the internal electrode layers 3 is Ni, a method of firing under a low oxygen partial pressure (a reducing atmosphere) is used so as not to reduce the dielectrics.

A thickness of each of the internal electrode layers 3 may be suitably determined in accordance with the use object, etc., but normally it is preferably 0.5 to 5 μm, and particularly 0.5 to 2.5 μm or so.

The dielectric layers 2 are composed of a plurality of ceramic particles. A composition of ceramic particles composing the dielectric layers 2 is not particularly limited and is composed of, for example, a dielectric ceramic composition including a main component expressed by {(Ba_{(1-x-y)}CaₓSr_{y})O}_{A}(Ti_{(1-z)}Zr_{z})_{B}O₂. Note that all of “A”, “B”, “x”, “y” and “z” are in any ranges. As a subcomponent included with the main component in the dielectric ceramic composition, a subcomponent including at least one kind selected from oxides of Sr, Y, Gd, Th, Dy, V, Mo, Ho, Zn, Cd, Ti, Sn, W, Ba, Ca, Mn, Mg, Cr, Si and P may be mentioned.

By adding the subcomponent, low temperature firing becomes possible without deteriorating dielectric characteristics of the main component, reliability defects in the case of making the dielectric layers 2 thinner can be reduced, and a long lifetime can be attained. Note that, in the present invention, a composition of the ceramic particle composing the dielectric layer 2 is not limited to the above.

The number of layers, a thickness and other conditions of the dielectric layers 2 may be suitably determined in accordance with the object and use, but in the present embodiment, a thickness of each dielectric layer 2 is preferably 0.5 μm to 5 μm, and more preferably 0.5 to 2.0 μm.

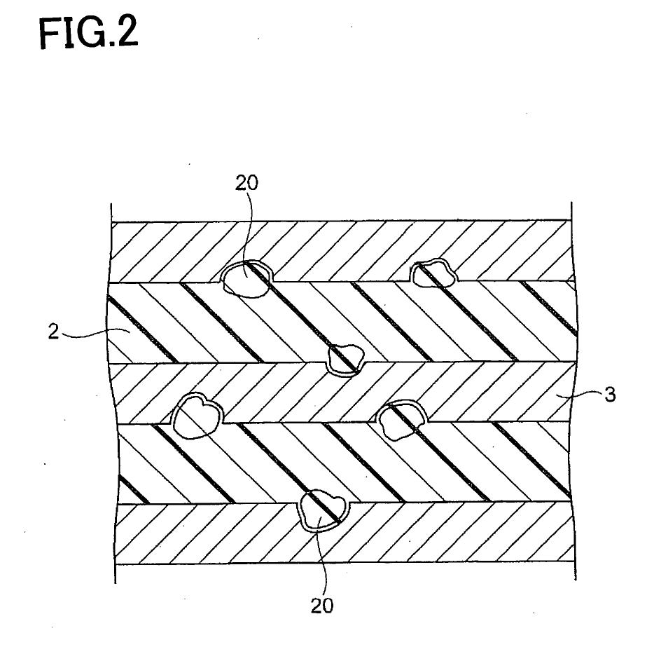

In the present embodiment, as shown in FIG. 2, the dielectric layers 2 include ceramic particles 20 protruding to the internal electrode layers 3 (note that, in FIG. 2, other ceramic particles composing the dielectric layers 2 than the ceramic particle 20 protruding to the internal electrode layer 3 are omitted). The protruding ceramic particle 20 is connected to other ceramic particles (not shown) composing the dielectric layer while protruding to the internal electrode layer 3. Note that, in the present embodiment, the protruding ceramic particles 20 are mainly formed as a result that a later-explained second common material (ceramic powder) included in the dielectric paste for forming the internal electrode layers is sintered near boundary surfaces of the internal electrode layers 3 and the dielectric layers 2.

In the present embodiment, the second common material included in the conductive paste becomes the protruding ceramic particles 20 after sintering, the anchor effect by the ceramic particles 20 to the internal electrode layers 3 leads to heightening of bonding strength between the internal electrode layers 3 and the dielectric layers 2, consequently, arising of cracks (particularly, arising of cracks caused by delamination) can be effectively prevented.

Moreover, in the present embodiment, since an average particle diameter of the second common material included in the conductive paste for forming the internal electrode layers is controlled to be in a later-explained predetermined range, the protruding ceramic particles 20 mainly formed by sintering the second common material near the boundary surfaces of the internal electrode layers 3 and the dielectric layers 2 can be configured so as not to penetrate the internal electrode layers 3. Therefore, they do not cause breakings of the internal electrode layers 3, bonding strength between the internal electrode layers and the dielectric layers can be heightened, arising of cracks is effectively prevented and, at the same time, a high capacitance can be realized.

A conductive material included in the external electrodes 4 is not particularly limited and Cu, a Cu alloy, Ni and Ni alloy, etc. are normally used. Note that Ag and an Ag—Pd alloy, etc. may be naturally used. Note that, in the present embodiment, inexpensive Ni, Cu and alloys of these may be used.

A thickness of each external electrode layer may be suitably determined and is normally 10 to 50 μm or so.

Production Method of Multilayer Ceramic Capacitor

Next, a production method of a multilayer ceramic capacitor 1 will be explained. In the present embodiment, a green chip is produced by the normal printing method or sheet method using paste, and after firing the same, external electrodes are printed or transferred and firing. Below, the production method will be explained specifically.

First, a dielectric material included in the dielectric layer paste is prepared and made to be slurry so as to fabricate dielectric layer paste.

The dielectric layer paste may be organic slurry obtained by kneading the dielectric material with an organic vehicle or water based slurry.

As the dielectric material, various compounds to be composite oxides and oxides, such as carbonate, nitrate, hydroxide and organic metal compound, etc., and mixed for use. The dielectric material is used as powder having an average particle diameter of normally 0.4μ or smaller, and preferably 0.1 to 0.3 μm. Note that finer powder than a thickness of the ceramic green sheet is preferably used to form an extremely thin ceramic green sheet.

An organic vehicle is obtained by dissolving a binder in an organic solvent. The binder to be used for the organic vehicle is not particularly limited and may be suitably selected from a variety of normal binders, such as ethyl cellulose and polyvinyl butyral. Also, the organic solvent to be used is not particularly limited and may be suitably selected from a variety of organic solvents, such as terpineol, butyl carbitol, acetone, and toluene, in accordance with a method to be used, such as the printing method and sheet method.

Also, when using water based slurry as dielectric layer paste, a water based vehicle obtained by dissolving a water-soluble binder and dispersant, etc. in water may be kneaded with the dielectric material. The water-soluble binder used for the water based vehicle is not particularly limited and, for example, polyvinyl alcohol, cellulose and water-soluble acrylic resin, etc. may be used.

In the present embodiment, as conductive paste for forming internal electrode layers 3, paste fabricated by kneading a conductive material particles, a first common material composed of ceramic powder, a second common material composed of ceramic powder having a larger average particle diameter than that of the first common material and the organic vehicle explained above is used.

The most significant characteristics of the present embodiment is to use paste including the first common material and the second common material in addition to conductive particle as conductive paste for forming the internal electrode layers 3. Particularly, by using such paste, arising of cracks (particularly, arising of cracks caused by delamination) can be effectively prevented and the short-circuit defect rate and the voltage resistance defect rate can be reduced.

As the conductive material particle, the conductive materials composed of a variety of conductive metals and alloys explained above, a variety of oxides to be the conductive materials after firing, organic metal compounds and resonates, etc. may be mentioned. Particularly, it is preferable to use particles including Ni as the main component, particles having a Ni content of 90 wt % or larger are more preferable, and particles having a nickel content of 95 wt % or larger are furthermore preferable. Note that an average particle diameter of the conductive material particles is preferably 0.1 μm to 0.7 μm, and more preferably 0.1 μm to 0.3 μm.

An average particle diameter of the first common material is 1/20 to ½ of an average particle diameter of the conductive material particles and is preferably 1/15 to ⅕. The first common material mainly exhibits an effect of preventing spheroidizing of internal electrode layers caused by grain growth of conductive material particles in a firing step. Furthermore, by preventing spheroidizing of the internal electrode layers, a decline of capacitance can be effectively prevented. When the average particle diameter of the first common material becomes less than 1/20 of that of the conductive material particles, dispersion into the conductive material paste becomes difficult. While when it is larger than ½, the effect of suppressing grain growth of the conductive material particles cannot be obtained. Note that the first common material is not particularly limited as far as it is composed of ceramic powder, but a dielectric material having the same composition as that of the dielectric material used in the dielectric layer paste is preferably used.

A content of the first common material in the conductive material paste is preferably 5 to 35 parts by weight, and more preferably 10 to 25 parts by weight with respect to 100 parts by weight of the conductive material particles. When the content of the first common material is too small, the effect of suppressing spheroidizing of the internal electrode layers 3 is hard to be obtained and the capacitance is liable to decline. While, when the content is too large, coverage of the internal electrode layers 3 after firing declines, consequently, the capacitance is liable to decline.

The second common material is a common material having a larger average particle diameter than that of the first common material, and the average particle diameter is 1/10 to ½, preferably ⅕ to ⅓ of an average thickness of the internal electrode layers 3 after firing. The second common material is sintered near boundary surfaces of the internal electrode layers 3 and the dielectric layers 2, as a result, it exists as ceramic particles 20 protruding to the internal electrode layers 3 as shown in FIG. 2 after firing. Due to the anchor effect by the protruding ceramic particles 20 to the internal electrode layers 3, bonding strength between the internal electrode layers 3 and the dielectric layers 2 becomes high, consequently, arising of cracks (particularly, arising of cracks caused by delamination) can be effectively prevented.

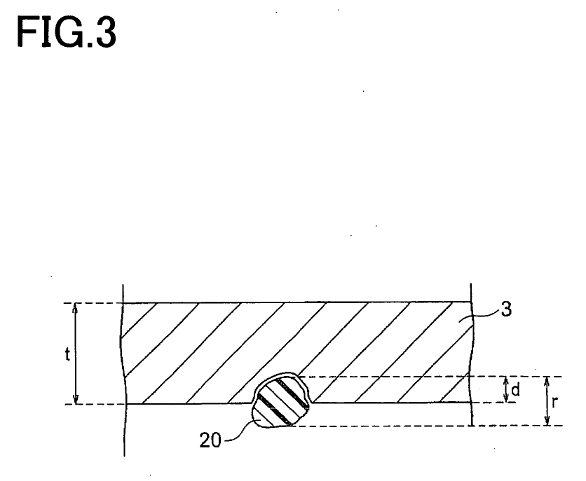

Particularly, in the present embodiment, as a result of making an average particle diameter of the second common material to 1/10 or larger than an average thickness of the internal electrode layers 3, it can be configured that a protruding depth (d) of the ceramic particles 20 into the internal electrode layers 3 is preferably 10% or deeper of a thickness (t) of the internal electrode layers 3 as shown in FIG. 3. Namely, for example, when the thickness (t) of the internal electrode layers 3 is 1 μm, it can be configured to protrude into the internal electrode layers 3 preferably by the depth (d) of 0.1 μm or deeper. Due to the configuration, the anchor effects by the ceramic particles 20 to the internal electrode layers 3 can be enhanced. Note that, in FIG. 3, illustration is omitted except for the internal electrode layer 3 and the ceramic particle 20. When the depth (d) is too shallow, the anchor effect tends to decline.

Furthermore, as a result that the average particle diameter of the second common material is ½ or smaller of an average thickness of the internal electrode layers 3, the configuration that the ceramic particles 20 do not penetrate the internal electrode layers 3 can be attained. Due to the configuration, a reduction of capacitance due to electrode breakings can be effectively prevented. Also, in the present embodiment, by controlling the average particle diameter of the second common material to ½ or smaller of the average thickness of the internal electrode layers 3, the configuration that the second common material does not adversely affect thicknesses of the internal electrode layers 3 and the dielectric layers 2 can be obtained. Therefore, the second common material does not affect thicknesses of adjacent dielectric layers, and a phenomenon that adjacent dielectric layers become partially thin dose not arise. Therefore, in the present embodiment, arising of short-circuit defects and voltage resistant defects caused by such a phenomenon can be effectively prevented.

When the average particle diameter of the second common material become less than 1/10 of an average thickness of the internal electrode layers 3, a crystal particle diameter (r) of the ceramic particles 20 included in the sintered body becomes small and the anchor effect by the ceramic particles 20 becomes insufficient. While, when it is larger than ½, the crystal particle diameter (r) of the ceramic particles 20 becomes too large, as a result, it is configured that the internal electrode layers 3 are penetrated, electrode breakings tend to arise easily, and the short-circuit defect rate and the voltage resistance defect rate tend to be deteriorated.

The average particle diameter of the second common material may be suitably set in the above range in accordance with a thickness of the internal electrode layers 3, but is preferably 0.2 to 0.5 μm.

A content of the second common material in the conductive paste is preferably larger than 1 part by weight and less than 15 parts by weight, and more preferably 3 parts by weight to 8 parts by weight with respect to 100 parts by weight of the conductive material particles. When the content of the second common material is too small, the anchor effect to the internal electrode layers 3 by the ceramic particles 20 protruding to the internal electrode layers 3 explained above is hard to be obtained. While, when the content of the second common material is too large, the second common material moves to the dielectric layer 2 side and affects on thicknesses of adjacent dielectric layers 2, as a result, it is liable that the short-circuit defect rate and voltage resistant defect rate are deteriorated. Note that the second common material is not particularly limited as far as it is composed of ceramic powder, but a dielectric material having the same composition as that of the dielectric material used for the dielectric layer paste is preferably used.

The external electrode paste may be fabricated by kneading the conductive material powder explained above with an organic vehicle.

A content of the organic vehicle in each paste explained above is not particularly limited and may be a normal content, for example, the binder is 1 to 5 wt % or so and the solvent is 10 to 50 wt % or so. Also, additives selected from a variety of dispersants, plasticizers, dielectrics and insulators, etc. may be included in each paste. A total content thereof is preferably not larger than 10 wt %.

When using the printing method, the dielectric layer paste and the conductive material paste are stacked and printed on a substrate, such as PET, cut to be a predetermined shape and removed from the substrate to obtain a green chip.

When using the sheet method, the dielectric layer paste is used to form a green sheet, the conductive material paste is printed thereon, then, the results are stacked to obtain a green chip.

Before firing, binder removal processing is performed on the green chip. The binder removal processing may be suitably determined in accordance with a kind of a conductive material in the internal electrode layer paste, and when using Ni, a Ni alloy or other base metal as the conductive material, the oxygen partial pressure in the binder removal atmosphere is preferably 10⁻⁴⁵ to 10⁵ Pa. When the oxygen partial pressure is lower than the above range, the binder removal effect declines. While, when the oxygen partial pressure exceeds the above range, the internal electrode layers tend to be oxidized.

Also, as other binder removal conditions, the temperature raising rate is preferably 5 to 300° C./hour and more preferably 10 to 100° C./hour, the holding temperature is preferably 180 to 400° C. and more preferably 200 to 350° C., and the temperature holding time is preferably 0.5 to 24 hours and more preferably 2 to 20 hours. Also, the firing atmosphere is preferably in the air or a reducing atmosphere, and a preferable atmosphere gas in the reducing atmosphere is, for example, a wet mixed gas of N₂ and H₂.

An atmosphere at firing the green chip may be suitably determined in accordance with a kind of a conductive material in the conductive material paste, and when using Ni, a Ni alloy and other base metal as the conductive material, the oxygen partial pressure in the firing atmosphere is preferably 10⁻⁷ to 10⁻³ Pa. When the oxygen partial pressure is lower than the above range, a conductive material in the internal electrode layer is abnormally sintered to be broken in some cases. While, when the oxygen partial pressure exceeds the above range, the internal electrode layer tends to be oxidized.

Also, the holding temperature at firing is preferably 1100 to 1400° C., more preferably 1200 to 1380° C., and furthermore preferably 1260 to 1360° C. When the holding temperature is lower than the above range, densification becomes insufficient, while when exceeding the above range, breakings of electrodes due to abnormal sintering of the internal electrode layers, deterioration of capacity-temperature characteristics due to dispersion of the internal electrode layer component, and a reduction of the dielectric ceramic composition are easily caused.

As other firing conditions, the temperature rising rate is preferably 50 to 500° C./hour and more preferably 200 to 300° C./hour, the temperature holding time is preferably 0.5 to 8 hours and more preferably 1 to 3 hours, and the cooling rate is preferably 50 to 500° C./hour and more preferably 200 to 300° C./hour. Also, the firing atmosphere is preferably a reducing atmosphere and a preferable atmosphere gas to be used is, for example, a wet mixed gas of N₂ and H₂.

When firing in a reducing atmosphere, it is preferable that annealing is performed on the capacitor element body. Annealing is processing for re-oxidizing the dielectric layer and the IR lifetime is remarkably elongated thereby, so that the reliability is improved.

An oxygen partial pressure in the annealing atmosphere is preferably 0.1 Pa or higher, and particularly preferably 0.1 to 10 Pa. When the oxygen partial pressure is lower than the above range, re-oxidization of the dielectric layer becomes difficult, while when exceeding the above range, the internal electrode layers tend to be oxidized.

The holding temperature at annealing is preferably 1100° C. or lower, and particularly preferably 500 to 1100° C. When the holding temperature is lower than the above range, oxidization of the dielectric layer becomes insufficient, so that the IR becomes low and the IR lifetime becomes short easily. On the other hand, when the holding temperature exceeds the above range, not only the internal electrode layers are oxidized to reduce the capacity, but the internal electrode layers react with the dielectric base material, and deterioration of the capacity-temperature characteristics, a decline of the IR and a decline of the IR lifetime are easily caused. Note that the annealing may be composed only of a temperature raising step and a temperature lowering step. Namely, the temperature holding time may be zero. In this case, the holding temperature is a synonym of the highest temperature.

As other annealing conditions, the temperature holding time is preferably 0 to 20 hours and more preferably 2 to 10 hours, and the cooling rate is preferably 50 to 500° C./hour and more preferably 100 to 300° C./hour. Also, a preferable atmosphere gas of annealing is, for example, a wet N₂ gas, etc.

In the above binder removal processing, firing and annealing, for example, a wetter, etc. may be used to wet the N₂ gas and mixed gas, etc. In this case, the water temperature is preferably 5 to 75° C. or so.

The binder removal processing, firing and annealing may be performed continuously or separately. When performing continuously, the atmosphere is changed without cooling after the binder removal processing, continuously, the temperature is raised to the holding temperature at firing to perform firing. Next, it is cooled and the annealing is preferably performed by changing the atmosphere when the temperature reaches to the holding temperature of the annealing. On the other hand, when performing them separately, at the time of firing, after raising the temperature to the holding temperature of the binder removal processing in an atmosphere of a nitrogen gas or a wet nitrogen gas, the atmosphere is changed, and the temperature is preferably furthermore raised. After that, after cooling the temperature to the holding temperature of the annealing, it is preferable that the cooling continues by changing the atmosphere again to a N₂ gas or a wet N₂ gas. Also, in the annealing, after raising the temperature to the holding temperature under the N₂ gas atmosphere, the atmosphere may be changed, or the entire process of the annealing may be in a wet N₂ gas atmosphere.

End surface polishing, for example, by barrel polishing or sand blast, etc. is performed on the capacitor element body obtained as above, and the external electrode paste is printed or transferred and fired to form external electrodes 4. A firing condition of the external electrode paste is preferably, for example, at 600 to 800° C. in a wet mixed gas of N₂ and H₂ for 10 minutes to 1 hour or so. A cover layer is formed by plating, etc. on the surface of the external electrodes 4 if necessary.

A multilayer ceramic capacitor of the present invention produced as above is mounted on a print substrate, etc. by soldering, etc. and used for a variety of electronic apparatuses, etc.

An embodiment of the present invention was explained above, but the present invention is not limited to the embodiment and a variety of modifications may be naturally made within the scope of the present invention.

For example, in the above embodiment, a multilayer ceramic capacitor was explained as an example of a multilayer ceramic electronic device according to the present invention, however, the multilayer ceramic electronic device according to the present invention is not limited to multilayer ceramic capacitors and may be any as far as it has the configuration explained above.

### EXAMPLES

Below, the present invention will be explained based on further detailed examples, but the present invention is not limited to the examples.

### Example 1

First, as starting materials for producing a dielectric material, (BaTiO₃) as a main component material and Y₂O₃, V₂O₅, CrO, MgO, SiO₂ and CaO as subcomponent materials having an average particle diameter of 0.2 μm were prepared. Next, the prepared starting materials were wet mixed by a ball mill for 16 hours to fabricate a dielectric material.

The dielectric material fabricated as above in an amount of 100 parts by weight, an acrylic resin in an amount of 4.8 parts by weight, ethyl acetate in an amount of 100 parts by weight, mineral spirit in an amount of 6 parts by weight and toluene in an amount of 4 parts by weight were mixed by a ball mill to form paste, so that dielectric layer paste was obtained.

Next, Ni particles having an average particle diameter of 0.2 μm in an amount of 100 parts by weight, BaTiO₃ (an average particle diameter: 0.05 μm) as a first common material in an amount of 20 parts by weight, BaTiO₃ (an average particle diameter: 0.5 μm) as a second common material in an amount shown in Table 1, an organic vehicle (obtained by dissolving 8 parts by weight of ethyl cellulose in 92 parts by weight of terpineol) in an amount of 40 parts by weight, and terpineol in an amount of 10 parts by weight were kneaded by a triple-roll to form paste, so that conductive material paste for forming internal electrode layers was obtained.

Next, Cu particles having an average particle diameter of 0.5 μm in an amount of 100 parts by weight, an organic vehicle (obtained by dissolving 8 parts by weight of ethyl cellulose resin in 92 parts by weight of terpineol) in an amount of 35 parts by weight and terpineol in an amount of 7 parts by weight were kneaded to form paste, so that external electrode paste was obtained.

Next, the dielectric layer paste was used to form a green sheet on a PET film, a conductive material paste for internal electrode layers is printed thereon, then, the green sheet was removed from the PET film. Next, the green sheets and protective green sheets (the internal electrode paste is not printed thereon) were stacked, pressed to bond, so that a green chip was obtained. The number of stacked layers having internal electrodes was 220. Note that, in the present embodiment, printing of the conductive material paste was performed to give a thickness of 1.0 μm to each internal electrode after firing.

Next, the green chip is cut to be a predetermined size and subjected to binder removal processing, firing and annealing, so that a multilayer ceramic fired body was obtained.

The binder removal processing was performed under a condition of temperature raising time of 15° C./hour, holding temperature of 280° C. and holding time of 8 hours in the air.

The firing was performed under a condition of temperature raising time of 200° C./hour, holding temperature of 1280 to 1320° C., holding time of 2 hours and cooling rate of 300° C./hour in an atmosphere of wet mixed gas of N₂+H₂ (the oxygen partial pressure was 10⁻⁹).

The annealing was performed under a condition of holding temperature of 900° C., temperature holding time of 9 hours and cooling rate of 300° C./hour in an atmosphere of wet N₂ gas (the oxygen partial pressure was 10⁻⁵). Note that a wetter with a water temperature of 35° C. was used to wet the atmosphere gases at the time of firing and annealing.

Next, after polishing end surfaces of the multilayer ceramic fired body by sand blast, the external electrode paste was transferred to the end surfaces, firing at 800° C. was performed for 10 minutes in the wet N₂+H₂ atmosphere to form external electrodes, and a multilayer ceramic capacitor sample configured as shown in FIG. 1 was obtained. In the present embodiment, as shown in Table 1, an amount of the second common material (BaTiO₃ having an average particle diameter of 0.5 μm) included in the conductive material paste for internal electrode layers was changed to produce samples No. 1 to 11. Note that the sample No. 1 is a sample without adding the second common material to the conductive material paste.

A size of each of the thus obtained samples was 1.0 mm×0.5 nm×0.5 mm, the number of dielectric layers sandwiched by internal electrode layers was 220, a thickness of each dielectric layer was 1.0 μm, and a thickness of each internal electrode layer was 1.0 μm.

A crack arising rate, capacitance, a short-circuit defect rate, a voltage resistance defect rate and a coverage rate of internal electrode layers of the obtained capacitor samples were evaluated, respectively.

Crack Arising Rate

A fired surface of each of the obtained capacitor simples was polished to visually observe the stacked state, and existence of the surface cracks was confirmed. The confirmation of existence of surface cracks was performed on 10000 capacitor samples. Based on results of the exterior inspection, a rate of samples with surface cracks in 10000 of capacitor samples was calculated and the crack arising rate was obtained. In the present embodiment, those with a crack arising rate of 1000 ppm or lower were considered preferable. The results are shown in Table 1.

Capacitance

Capacitance was measured by using a digital LCR meter at a reference temperature of 25° C. under a condition of a frequency of 1 kHz and an input signal level of 1.0 Vrms. The results are shown in Table 1. Note that, in the present embodiment, the measurement results of capacitance were evaluated by a ratio to capacitance of the sample No. 1 without adding the second common material to the conductive material paste, and within −10% was considered preferable. Namely, the sample No. 2 having capacitance of “−1%” exhibited a result that the capacitance was lower by 1% comparing with that of the sample No. 1. The results are shown in Table 1.

Short-Circuit Defect Rate

The short-circuit defect rate was measured by preparing 100 capacitor samples and checking the number of samples with a short-circuit defect. Specifically, an insulation resistance tester (E2377A Multimeter made by Hewlett Packard) was used to measure the resistance value, and samples having a resistance value of 100 kΩ or lower were considered short-circuit defective samples, and a ratio of short-circuit defective samples in all measured samples was used as a short-circuit defect rate. In the present embodiment, 50% or lower were considered preferable. The results are shown in Table 1.

Voltage Resistance Defect Rate

The voltage resistance defect rate was evaluated by applying a direct current voltage of 12 times as high as a rated voltage (4.0V) to 200 capacitor samples for 3 seconds, judging samples having a resistance of less than 10⁴Ω as voltage resistance defects, and obtaining a rate of voltage resistance defective samples in measured samples. In the present embodiment, 50% or lower were considered preferable. The results are shown in Table 1.

Coverage Rate of Internal Electrode Layer

By using the same method as in measuring an existence rate of protruding portions explained above, SEM observation was performed on a cut surface of an element body. Then, a coverage rate of the internal electrode layers was obtained from the obtained SEM picture. Specifically, when assuming that an ideal area of covering dielectric layers by internal electrode layers was 100% when there was no electrode breaking portion on the internal electrode layers, it was obtained by calculating a ratio of an area that the internal electrode layers actually cover the dielectric layers. Note that the coverage rate was obtained by using 10 SEM pictures measured on a visual scope of 50 μm×60 μm. As a result, all of the samples No. 3 to No. 10 exhibited a coverage rate of the internal electrode layers of 80% or higher.

TABLE 1

| | | | | | | Multilayer Ceramic Capacitor Sample | | | | | |
|---|---|---|---|---|---|---|---|---|---|---|---|
| | | | | | | | Second | | | | |
| | | | | | | | Common | | | | |
| | | | | | | | Material | | | | |
| | | | | | | | Particle | | | | |
| | Conductive Material Paste | | | | | | Diameter/ | Crack Arising | | Short- | Voltage |
| | | First Common | | Second Common | | Thickness | Internal | Rate | | Circuit | Resistance |
| | Ni | Material | | Material | | of Internal | Electrode | (ppm) | Capacitance | Defect Rate | Defect Rate |
| Sample | Powder | | (parts by | | (parts by | Electrode | Layer | 1000 ppm | (%) | (%) | (%) |
| No. | (μm) | (μm) | weight) | (μm) | weight) | Layer (μm) | Thickness | or lower | within −10% | 50% or lower | 50% or lower |
| 1 | 0.2 | 0.05 | 20 | — | 0 | 1.0 | 0.50 | 69000 | 0 | 12 | 16 |
| 2 | 0.2 | 0.05 | 20 | 0.5 | 1 | 1.0 | 0.50 | 54000 | −1 | 22 | 10 |
| 3 | 0.2 | 0.05 | 20 | 0.5 | 1.2 | 1.0 | 0.50 | 500 | −1 | 20 | 15 |
| 4 | 0.2 | 0.05 | 20 | 0.5 | 2 | 1.0 | 0.50 | 300 | −2 | 21 | 14 |
| 5 | 0.2 | 0.05 | 20 | 0.5 | 3 | 1.0 | 0.50 | 0 | −3 | 24 | 26 |
| 6 | 0.2 | 0.05 | 20 | 0.5 | 5 | 1.0 | 0.50 | 0 | −5 | 30 | 32 |
| 7 | 0.2 | 0.05 | 20 | 0.5 | 6 | 1.0 | 0.50 | 0 | −5 | 30 | 28 |
| 8 | 0.2 | 0.05 | 20 | 0.5 | 8 | 1.0 | 0.50 | 0 | −5 | 32 | 34 |
| 9 | 0.2 | 0.05 | 20 | 0.5 | 10 | 1.0 | 0.50 | 0 | −5 | 39 | 40 |
| 10 | 0.2 | 0.05 | 20 | 0.5 | 13 | 1.0 | 0.50 | 0 | −6 | 45 | 46 |
| 11 | 0.2 | 0.05 | 20 | 0.5 | 15 | 1.0 | 0.50 | 0 | −6 | 72 | 60 |

Note that, in Table 1, adding amounts of the first common material and the second common material in the conductive material paste are ratio with respect to 100 parts by weight of Ni powder, and the capacitance was expressed by a ratio with respect to capacitance of the sample No. 1. Also, in Table 1, “second common material particle diameter/internal electrode layer thickness” means “an average particle diameter of the second common material in the conductive material paste/a thickness of each internal electrode layer after sintering”. It will be the same in Table 2 to Table 5 below.

Evaluation

From Table 1, all of the samples No. 3 to No. 10 including the second common material (BaTiO₃ having a particle diameter of 0.5 μm) in a range of 1.2 to 13 parts by weight as the conductive material paste for internal electrode layers with respect to 100 parts by weight of Ni powder exhibited excellent results in the crack arising rate, capacitance, short-circuit defect rate and voltage resistance defect rate. Note that when observing a cut surface of the sintered body by SEM for the samples, it was confirmed that ceramic particles 20 protruding to internal electrode layers 3 as shown in FIG. 2 were preferably formed.

On the other hand, both of the sample No. 1, wherein the second common material was not included in the conductive material paste, and the sample No. 2, wherein a content of the second common material was reduced to 1 part by weight, exhibited tendency that the crack arising rate was deteriorated. Note that when observing the cut surface of the sintered body by SEM on the samples, formation of ceramic particles 20 protruding to the internal electrode layers 3 was insufficient.

The sample No. 11, wherein a content of the second common material was 15 parts by weight, exhibited a tendency of deteriorating the short-circuit defect rate and voltage resistance defect rate. Note that, in the sample No. 11, it is considered that since the content of the second common material in the conductive material paste was too large, the second common material moved to the dielectric layer 2 side and affected thicknesses of adjacent dielectric layers 2, consequently, the short-circuit defect rate and voltage resistance defect rate were deteriorated.

### Example 2

Other than using Ni powder having an average particle diameter of 0.1 μm as the Ni powder included in the conductive material paste and changing a content of the second common material as shown in Table 2, multilayer ceramic capacitor samples were produced in the same way as in the example 1 and the evaluation was made in the same way as in the example 1. The results are shown in Table 2.

TABLE 2

| | | | | | | Multilayer Ceramic Capacitor Sample | | | | | |
|---|---|---|---|---|---|---|---|---|---|---|---|
| | | | | | | | Second | | | | |
| | | | | | | | Common | | | | |
| | | | | | | | Material | | | | |
| | | | | | | | Particle | | | | |
| | Conductive Material Paste | | | | | | Diameter/ | Crack Arising | | Short- | Voltage |
| | | First Common | | Second Common | | Thickness | Internal | Rate | | Circuit | Resistance |
| | Ni | Material | | Material | | of Internal | Electrode | (ppm) | Capacitance | Defect Rate | Defect Rate |
| Sample | Powder | | (parts by | | (parts by | Electrode | Layer | 1000 ppm | (%) | (%) | (%) |
| No. | (μm) | (μm) | weight) | (μm) | weight) | Layer (μm) | Thickness | or lower | within −10% | 50% or lower | 50% or lower |
| 12 | 0.1 | 0.05 | 20 | — | 0 | 1.0 | 0.50 | 87000 | 0 | 8 | 12 |
| 13 | 0.1 | 0.05 | 20 | 0.5 | 1 | 1.0 | 0.50 | 60000 | −1 | 10 | 13 |
| 14 | 0.1 | 0.05 | 20 | 0.5 | 3 | 1.0 | 0.50 | 900 | −2 | 10 | 16 |
| 15 | 0.1 | 0.05 | 20 | 0.5 | 5 | 1.0 | 0.50 | 100 | −5 | 15 | 16 |
| 16 | 0.1 | 0.05 | 20 | 0.5 | 13 | 1.0 | 0.50 | 0 | −5 | 21 | 20 |
| 17 | 0.1 | 0.05 | 20 | 0.5 | 15 | 1.0 | 0.50 | 0 | −7 | 52 | 48 |

From Table 2, the same tendency as that in the example 1 was confirmed also in the case of using Ni powder having an average particle diameter of 0.1 μm as the Ni particle.

### Example 3

Other than changing a ratio of the first common material included in the conductive material paste as shown in Table 3, multilayer ceramic capacitor samples were produced in the same way as in the sample No. 6 in example 1, and evaluation was made in the same way as in the example 1. The results are shown in Table 3.

TABLE 3

| | | | | | | Multilayer Ceramic Capacitor Sample | | | | | |
|---|---|---|---|---|---|---|---|---|---|---|---|
| | | | | | | | Second | | | | |
| | | | | | | | Common | | | | |
| | | | | | | | Material | | | | |
| | | | | | | | Particle | | | | |
| | Conductive Material Paste | | | | | | Diameter/ | Crack Arising | | Short- | Voltage |
| | | First Common | | Second Common | | Thickness | Internal | Rate | | Circuit | Resistance |
| | Ni | Material | | Material | | of Internal | Electrode | (ppm) | Capacitance | Defect Rate | Defect Rate |
| Sample | Powder | | (parts by | | (parts by | Electrode | Layer | 1000 ppm | (%) | (%) | (%) |
| No. | (μm) | (μm) | weight) | (μm) | weight) | Layer (μm) | Thickness | or lower | within −10% | 50% or lower | 50% or lower |
| 18 | 0.2 | — | 0 | 0.5 | 5 | 1.0 | 0.50 | 2000 | −15 | 20 | 24 |
| 19 | 0.2 | 0.05 | 4 | 0.5 | 5 | 1.0 | 0.50 | 1400 | −11 | 18 | 20 |
| 20 | 0.2 | 0.05 | 5 | 0.5 | 5 | 1.0 | 0.50 | 700 | −9 | 20 | 20 |
| 6 | 0.2 | 0.05 | 20 | 0.5 | 5 | 1.0 | 0.50 | 0 | −5 | 30 | 32 |
| 21 | 0.2 | 0.05 | 35 | 0.5 | 5 | 1.0 | 0.50 | 800 | −10 | 24 | 30 |
| 22 | 0.2 | 0.05 | 40 | 0.5 | 5 | 1.0 | 0.50 | 3000 | −12 | 25 | 32 |

From Table 3, in the sample No. 18 not including the first common material and in the sample No. 19, wherein a content of the first common material was reduced to 4 parts by weight, spheroidizing of internal electrodes arose due to sintering, consequently, the crack rising rate was deteriorated and the capacitance declined. On the other hand, in the sample No. 22, wherein a content of the first common material was increased to 40 parts by weight, the result was a deterioration of the crack arising rate and a decline of capacitance. Note that, in the sample No. 22, a cause of deteriorating the crack arising rate was considered to be a change of sintering behavior, and a cause of declining the capacitance was considered that the coverage rate of the internal electrode layers became low.

On the other hand, all of samples No. 6, No. 20 and No. 21, wherein a content of the first common material was in the preferable range of the present invention, exhibited preferable results that the crack arising rate, capacitance, short-circuit defect rate and voltage resistance defect rate are in predetermined ranges.

### Example 4

Other than changing a printing thickness of the conductive material paste for internal electrode layers and changing a thickness of each internal electrode layer after firing as shown in Table 4, multilayer ceramic capacitor samples were produced in the same way as in the sample No. 6 in example 1 and an evaluation was made in the same way as in the example 1. The results are shown in Table 4.

TABLE 4

| | | | | | | Multilayer Ceramic Capacitor Sample | | | | | |
|---|---|---|---|---|---|---|---|---|---|---|---|
| | | | | | | | Second | | | | |
| | | | | | | | Common | | | | |
| | | | | | | | Material | | | | |
| | | | | | | | Particle | | | | |
| | Conductive Material Paste | | | | | | Diameter/ | Crack Arising | | Short- | Voltage |
| | | First Common | | Second Common | | Thickness | Internal | Rate | | Circuit | Resistance |
| | Ni | Material | | Material | | of Internal | Electrode | (ppm) | Capacitance | Defect Rate | Defect Rate |
| Sample | Powder | | (parts by | | (parts by | Electrode | Layer | 1000 ppm | (%) | (%) | (%) |
| No. | (μm) | (μm) | weight) | (μm) | weight) | Layer (μm) | Thickness | or lower | within −10% | 50% or lower | 50% or lower |
| 23 | 0.2 | 0.05 | 20 | 0.5 | 5 | 3.0 | 0.17 | 300 | −6 | 20 | 21 |
| 24 | 0.2 | 0.05 | 20 | 0.5 | 5 | 1.5 | 0.33 | 100 | −8 | 25 | 25 |
| 6 | 0.2 | 0.05 | 20 | 0.5 | 5 | 1.0 | 0.50 | 0 | −5 | 30 | 32 |
| 25 | 0.2 | 0.05 | 20 | 0.5 | 5 | 0.8 | 0.63 | 0 | −11 | 35 | 36 |
| 26 | 0.2 | 0.05 | 20 | 0.5 | 5 | 0.5 | 1.00 | 0 | −13 | 53 | 51 |

From Table 4, all of the samples No. 6, No. 23 and No. 24, wherein “second common material particle diameter/internal electrode layer thickness” as a ratio of an average particle diameter of the second common material in the conductive material paste and a thickness of each internal electrode layer after sintering was 1/10 (=0.1) to ½ (=0.50), exhibited preferable results that the crack arising rate, capacitance, short-circuit defect rate and voltage resistance defect rate were in predetermined ranges.

On the other hand, the samples No. 25 and No. 26, wherein the “second common material particle diameter/internal electrode layer thickness” was larger than ½ (=0.50) resulted in a decline of capacitance. Particularly, in the sample No. 26, the short-circuit defect rate and voltage resistance defect rate are also deteriorated. Note that a cause of declining the capacitance in these samples is considered to be an increase of electrode breaking portions. Also, in the sample No. 26, a cause of deteriorating the short-circuit defect rate and voltage resistance defect rate is considered that an average particle diameter of the second common material was too large so as to affect thicknesses of adjacent dielectric layers and, particularly, it was considered a phenomenon that the adjacent dielectric layers becoming partially thin arose.

### Example 5

Other than using BaTiO₃ having an average particle diameter of 0.25 μm as the second common material included in the dielectric material paste for internal electrode layers, changing a printing thickness of the conductive material paste for internal electrode layers, and changing a thickness of each internal electrode layer after firing as shown in Table 5, multilayer ceramic capacitor samples were produced in the same way as in the sample No. 6 in example 1, and an evaluation was made in the same way as in the example 1. The results are shown in Table 5.

TABLE 5

| | | | | | | Multilayer Ceramic Capacitor Sample | | | | | |
|---|---|---|---|---|---|---|---|---|---|---|---|
| | | | | | | | Second | | | | |
| | | | | | | | Common | | | | |
| | | | | | | | Material | | | | |
| | | | | | | | Particle | | | | |
| | Conductive Material Paste | | | | | | Diameter/ | Crack Arising | | Short- | Voltage |
| | | First Common | | Second Common | | Thickness | Internal | Rate | | Circuit | Resistance |
| | Ni | Material | | Material | | of Internal | Electrode | (ppm) | Capacitance | Defect Rate | Defect Rate |
| Sample | Powder | | (parts by | | (parts by | Electrode | Layer | 1000 ppm | (%) | (%) | (%) |
| No. | (μm) | (μm) | weight) | (μm) | weight) | Layer (μm) | Thickness | or lower | within −10% | 50% or lower | 50% or lower |
| 27 | 0.2 | 0.05 | 20 | 0.25 | 5 | 3.0 | 0.08 | 2000 | −6 | 12 | 13 |
| 28 | 0.2 | 0.05 | 20 | 0.25 | 5 | 1.5 | 0.17 | 100 | −8 | 13 | 18 |
| 29 | 0.2 | 0.05 | 20 | 0.25 | 5 | 1.0 | 0.25 | 0 | −5 | 20 | 23 |
| 30 | 0.2 | 0.05 | 20 | 0.25 | 5 | 0.8 | 0.31 | 0 | −8 | 29 | 25 |

From Table 5, in the sample No. 27, wherein “second common material particle diameter/internal electrode layer thickness” as a ratio of an average particle diameter of the second common material in the conductive material paste and a thickness of each internal electrode layer after sintering was smaller than 1/10 (=0.1), the average particle diameter of the second common material became too small comparing with the thickness of the internal electrode layers and the effect of adding the second common material could not be obtained, consequently, the crack arising rate was deteriorated.

On the other hand, the samples No. 28 to No. 30, wherein the “second common material particle diameter/internal electrode layer thickness” was 1/10 (=0.1) to ½ (=0.50), exhibited preferable results that the crack arising rate, capacitance, short-circuit defect rate and voltage resistance defect rate were in predetermined ranges even in the case where an average particle diameter of the second common material was 0.25 μm.

What is claimed is:

1. A production method for producing a multilayer ceramic electronic device including dielectric layers and internal electrode layers, comprising the steps of:
forming a green sheet to be said dielectric layer after firing;
forming a pre-fired electrode layer to be said internal electrode layer after firing in a predetermined pattern on said green sheet by using a conductive material paste;
forming a green chip by successively stacking said green sheets and said pre-fired electrode layers; and
firing said green chip;
wherein the conductive material paste for forming said pre-fired electrode layer is composed at least of conductive material particles, a first common material composed of ceramic powder and a second common material composed of ceramic powder having a larger average particle diameter than that of said first common material;
an average particle diameter of said first common material is 1/20 to ½ of an average particle diameter of said conductive material particles; and
the average particle diameter of said second common material is 1/10 to ½ of an average thickness of said internal electrode layers after firing.

2. The production method of a multilayer ceramic electronic device as set forth in claim 1, wherein an average particle diameter of said second common material is 0.2 to 0.5 μm.

3. The production method of a multilayer ceramic electronic device as set forth in claim 1 or 2, wherein a content of said first common material in said conductive material paste is 5 to 35 parts by weight with respect to 100 parts by weight of said conductive material particles.

4. The production method of a multilayer ceramic electronic device as set forth in claim 1 or 2, wherein a content of said second common material in said conductive material paste is larger than 1 part by weight and less than 15 parts by weight with respect to 100 parts by weight of said conductive material particles.

5. The production method of a multilayer ceramic electronic device as set forth in claim 1 or 2, wherein a content of said first common material in said conductive material paste is 5 to 35 parts by weight with respect to 100 parts by weight of said conductive material particles, and a content of said second common material in said conductive material paste is larger than 1 part by weight and less than 15 parts by weight with respect to 100 parts by weight of said conductive material particles.
